(19) United States
(12) Patent Application Publication
(10) Pub. No.: US 2007/0136658 A1
(43) Pub. Date: Jun. 14, 2007

(54) Handling events in a descriptive context

(75) Inventors: Barry Alan Feigenbaum, Austin, TX (US); Michael A. Squillace, Austin, TX (US)

Correspondence Address: IBM CORP. (MRN);c/o LAW OFFICE OF MICHAEL R. NICHOLS, 3001 S. HARDIN BLVD., STE. 110, PMB 155, MCKINNEY, TX, 75070-7702, US

(73) Assignee: International Business Machines Corporation

(21) Appl. No.: 11/289,052

(22) Filed: Nov. 29, 2005

(51) Int. Cl. G06F 17/00; G06F 3/00

(52) U.S. Cl. 715/513; 715/700

(57) ABSTRACT

A method, computer program product, and data processing system for generating GUI code from a declarative specification is disclosed. In a preferred embodiment, a markup language, such as XML, is utilized to specify the hierarchical structure of an object-oriented GUI and the various attributes of its components. Additional special-purpose attributes and/or nested markup tags corresponding to particular types of event handlers and events are used to embed lines of non-markup program code (typically imperative program code) within the XML document. To produce the program code for the GUI, the XML document is processed and instructions for constructing the GUI to the XML document's specifications are generated. The embedded non-markup program code is formed into event handlers in the generated output program code, which are associated, in the output program code, with the GUI components to which they correspond.

### BACKGROUND OF THE INVENTION

1. Technical Field

The present invention relates generally to tools for generating graphical user interfaces (GUIs) and, more specifically, to a tool for generating graphical user interface code and event handlers from a declarative/descriptive representation of the GUI.

2. Description of the Related Art

The earliest interactive computers relied on tele-typewriter (TTY) or text terminals for interactive communication with a human operator. These early forms of human-computer interaction (HCI) allowed for only text- or character-based information exchange. Many computer software products today utilize a graphical user interface or GUI (typically pronounced like “gooey”). A GUI is visual means of human-computer interaction that utilizes pictures or other visual representations besides text or characters.

Most GUIs make use of visual controls that are displayed on the user's display and actuated by user input. Typical visual controls include, but are not limited to, buttons, text fields (for entering text), radio buttons, checkboxes, selection boxes, and menu bars. In a typical GUI, a pointing device, such as a mouse, is used to move a cursor around a display and actuate visual controls. GUIs usually also make use of static display components, such as labels and icons, which are intended to be displayed, but generally have no input function, per se. Sometimes these static display components may serve an input role, however, when they are moved around on the display relative to other features on the display (e.g., dragging an icon of a file to a trash can icon to delete a file, for example).

Many GUIs are what is known as a “windowing” interface, because they arrange information visually on a display in the form of panels or “windows” superimposed on a background called a “desktop.” In many systems, windows may be dragged to different locations on the display with a pointing device, enlarged, reduced, made to overlap with other windows. Typically, a window will contain a number of visual controls to allow a user to interact with a computer program by actuating the controls in the window. A special form of window, known as a “dialog box,” is displayed by a program when some input is required from a user.

Windows, visual controls, and static display components are what are known as GUI components, because they are the building blocks that make up the GUI. Some GUI components, such as windows, are known as “container components” (or simply “containers”), because they may contain other components. For example, a window may contain visual controls, such as a button or menu bar, and static display components, such as text labels or icons. A container may also contain another container. For example, in some windowing-based word processors, the word processor itself occupies a (main) window, while each file under editing occupies another window within the main window.

Container components include windows, but may also include other components, which may be visible or invisible. For example, the JAVA™ programming language produced by Sun Microsystems, Inc. of Mountain View, Calif., defines various visible container components, such as windows and dialog boxes, as well as invisible container components, such as the “java.awt.Panel” container component, which is used solely to group a number of contained components into a single unit. Some examples of containers include, but are not limited to, windows, dialog boxes, panels, tabbed panels, notebook pages, and any other GUI components that have a capability of containing one or more other GUI components.

The actual functionality for providing basic operations on GUI components, such as displaying the components or detecting user input directed at the components (e.g., from pointing at or clicking on a component with a pointing device), is often provided by system-level software, such as an operating system. Generally speaking, applications will issue calls to system-level software for creating and maintaining GUIs, while the system-level software detects user input events that are directed at particular GUI components and sends event notifications to the applications that are responsible for those GUI components.

For example, the WINDOWS® operating system produced by Microsoft, Inc. of Redmond, Wash. provides services for the creation of GUIs and relaying of user input events to appropriate applications. The main interface for the WINDOWS® operating system itself is a GUI as well. In other settings, higher-level system software may operate on top of an operating system kernel (e.g., as a daemon or background process) to provide GUI services. For example, “X11” is an open-source GUI engine that operates as a process in an operating system. X11 adopts a client-server model in that an X11 server process accepts requests from applications (clients) for providing GUI services and relays user input events that pertain to particular GUI components to the applications associated with those components.

Alternatively, an application may contain its own code for providing GUI services. Typically, this code will come in the form of a reusable code library for performing basic GUI operations.

Many modern programming language implementations have built-in features for producing GUIs, usually either by providing an interface to GUI services provided by system-level software or by including libraries of low-level GUI code for which an interface in the programming language is provided. The JAVA™ programming language, for example, is an object-oriented programming language that includes standard application programming interfaces (APIs) for defining GUIs. Two APIs that are currently part of the JAVA™ programming language standard are the Abstract Windowing Toolkit (AWT) API and the Swing API. In the JAVA™ programming language, as is typical of object-oriented GUI APIs, each type of GUI component is defined as a class.

In an object-oriented programming language, a class is a definition of a data type that includes a collection of data, called member variables, and a set of operations that may be performed on the data, called methods (or alternatively, member functions). An actual collection of data in the data type defined by a class is called an object. In object-oriented programming (OOP) parlance, an object is said to be an “instance” of the class, because it is a data structure that is defined in accordance with the class. The run-time process of generating an object in an object-oriented programming language is called “instantiation,” and an object that exists at run-time is said to be “instantiated.”

Object-oriented programming languages also typically provide for what is known as “inheritance.” Using an inheritance a new class (called a “descendant” class) can be defined in terms of one or more existing classes (called “base” classes) so that the descendant class inherits one or more of the member variables or methods of the base class. For example, in the JAVA™ programming language's AWT API, “Container” is a descendant class of a base class called “Component,” the “Container” class will include at least some of the methods and member variables of “Container.” We thus say that “Container” is descended from “Component.” In many cases, a descendant class will include additional methods or member variables that are not inherited from the base class.

Also, a descendent class may be written so as to override the base class's code for a particular method. For example, the base class “Container” may have a method called “show,” for displaying a GUI component, which the descendant class “Container” inherits. Since displaying a container (which may contain other components) is more specific than displaying a generic GUI component, the “Container” class may define different code for “show” than that of the “Component” class.

This is important, since in most object-oriented languages, an object in a descendant class is treated as being a more specific instance of the base class. Thus, a “Container” object may be stored in a variable of type “Component,” or a method that takes a “Component” as an argument can also take a “Container” as an argument, since a “Container” will inherit characteristics (i.e., member variables and methods) from “Component.” This ability to treat objects from descendant classes as if they were instances of base classes is called “polymorphism.”

In an object-oriented GUI API, such as those provided by the JAVA™ programming language, GUI components are instantiated as objects, and relationships are established between the instantiated objects in order to define the placement and behavior of GUI components with respect to each other. For example, a “containment relation” is a relationship between GUI components that relates a container component to the components contained by that container component. In the JAVA™ programming language, for example, a component typically enters into a containment relation with a container through a method of the container called “add.”

A typical GUI component has one or more attributes that define particular properties of the component. For example, a “button” component in a typical windowing GUI will have attributes that define the size of the button on the display, the text or graphics displayed on the face of the button, the background color of the button, a keyboard shortcut associated with the button, and the like. In general, the portion of program code (e.g., function, method, subroutine, procedure, etc.) that instantiates a GUI component will also contain a number of lines of code that set the attributes for that component to desired values. In the JAVA™ programming language and other object-oriented programming systems, for example, components generally have methods that can be executed to set particular attributes of the component.

GUIs, and in particular object-oriented GUIs, generally employ what are known as “event handlers” to process GUI events as they occur. Some examples of GUI events are a user keystroke, and the moving, clicking, or dragging of a mouse. An event handler is a portion of code (e.g., a function or an object) that contains instructions for responding to one or more events that may occur with respect to a component or set of components in a GUI. Most GUI-based programs are designed to execute in a generally idle state until directed by the user to perform some action via one or more GUI events. This style of programming is known as “event-driven programming.”

Programming GUIs, even in an object-oriented programming language such as JAVA™, is generally considered to be a very labor-intensive process. This is largely due to the fact that most commonly-used computer languages have an imperative semantics (i.e., they express programs in terms of sequences of instructions). While imperative languages are a natural fit for non-interactive “batch” processes, imperative languages tend to be relatively awkward to use for expressing the concepts that underlie most GUIs, namely a structured arrangement of GUI components and event-driven execution. Sequences of imperative instructions must be written to construct the GUI piece-by-piece. Consequently, GUI code tends to be rather complex and tedious to write.

A number of efforts in the GUI field have been directed to simplifying the process of constructing GUIs, and in particular, GUIs constructed in an object-oriented programming language. One way of achieving this goal is to provide tools or application programming interfaces (APIs) that allow GUIs to be specified using a “declarative” or “descriptive” representation. In a declarative language, the relationships between the various constructs in the language are explicitly declared or described in terms of the relationships themselves. One particularly convenient manner of specifying the hierarchical structure of an object-oriented GUI in a declarative manner is to utilize Extensible Markup Language (XML) This approach is described, in general, in commonly-assigned, co-pending U.S. patent application Ser. No. 10/392,806, published as US 20040183838 (LAHIRI) Sept. 23, 2004.

Extensible Markup Language, more commonly referred to as “XML,” is a character-based markup language that is designed for annotating data with semantic information that can be parsed by a computer. XML is used to provide a standardized syntax for information exchange between software processes.

XML by itself has a very minimal semantics, as XML merely provides a standardized syntax for imposing a hierarchical structure on data. XML, like HTML (Hypertext Markup Language) and other similar markup languages, uses tags to encode structural information about the data. HTML, for example, uses tags to encode structural (e.g., headings, section breaks, etc.) and formatting information about a hypertext document. XML, on the other hand, is more general than HTML. While HTML defines tags that have a particular semantics related to document structuring, XML does not define particular tags, but provides only a syntax for creating user-defined tags. It is up to a user (e.g., a programmer, database administrator, etc.) to define semantic tags in XML. What minimal semantics is provided by XML itself is essentially limited to the ability of XML tags to form information hierarchies through the nesting of tags and the ability to associate data attributes with individual tags.

Essentially, what this means is that XML can be used to create markup languages that can be parsed using off-the-shelf parsing code. This allows developers to create custom languages for data exchange without the hassle of having to write a parser for the language. For instance, one can create a custom markup language for encoding musical scores by using XML tags. It would not be necessary to write a parser for the language, since a generic XML parser would immediately be able to parse the language. In short, XML provides a standardized, platform-independent format for data exchange, which decouples the language syntax from the language semantics such that a standardized syntax can be used to encode structured data having an arbitrary choice of semantics.

Thus, XML enables one to create development tools that can convert a declarative representation of a GUI into sequential, imperative instructions for the computer to execute to construct the specified GUI. The output of such a tool generally only implements the relational structure of the GUI itself, however. It is still necessary in most cases for a programmer to further develop and modify the resulting program code to support the handling of GUI events. This can be among the more frustrating tasks a GUI developer must undertake, since it requires modifying computer-generated program code (i.e., program code the programmer must first become familiar with [no small task when dealing with computer-generated code], then make appropriate modifications to). Thus, ideally, one would like to avoid having to modify computer-generated GUI code to incorporate event handlers into the GUI.

What is needed, therefore, is a method of automatically generating a GUI from a declarative specification, in which the computer-generated output can be utilized without having to manually modify the output to include event handlers. The present invention provides a solution to this and other problems, and offers other advantages over previous solutions.

### SUMMARY OF THE INVENTION

Accordingly, the present invention provides a method, computer program product, and data processing system for generating GUI code from a declarative specification, in which no manual modification of the generated code is needed to support event handling. In a preferred embodiment, a markup language, such as XML, is utilized to specify the hierarchical structure of an object-oriented GUI and the various attributes of its components. Additional special-purpose attributes and/or nested markup tags corresponding to particular types of event handlers and events are used to embed lines of non-markup program code (typically imperative program code) within the XML document. To produce the program code for the GUI, the XML document is processed and instructions for constructing the GUI to the XML document's specifications are generated. The embedded non-markup program code is formed into event handlers in the generated output program code and are associated, in the output program code, with the GUI components to which they correspond. Thus, the resulting computer-generated program code implements not only the structure and appearance of the GUI itself, but also implements the necessary event handlers to respond to user actions and other events. Hence, the resulting code can be directly incorporated into an application program without subsequent manual alteration of the code.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a diagram providing an overview of the operation of a graphical user interface tool in accordance with a preferred embodiment of the present invention;

FIG. 2 is a diagram illustrating portions of a markup language file in which GUI components and event handlers are specified declaratively in accordance with a preferred embodiment of the present invention;

FIG. 3 is a diagram of an example GUI generated in accordance with a preferred embodiment of the present invention;

FIG. 4 is a diagram illustrating GUI source code generated in accordance with a preferred embodiment of the present invention;

FIG. 5 is a flowchart representation of a process of generating GUI and event handler source code in an interface generation tool in accordance with a preferred embodiment of the present invention; and

FIG. 6 is a block diagram of a data processing system in which a preferred embodiment of the present invention may be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

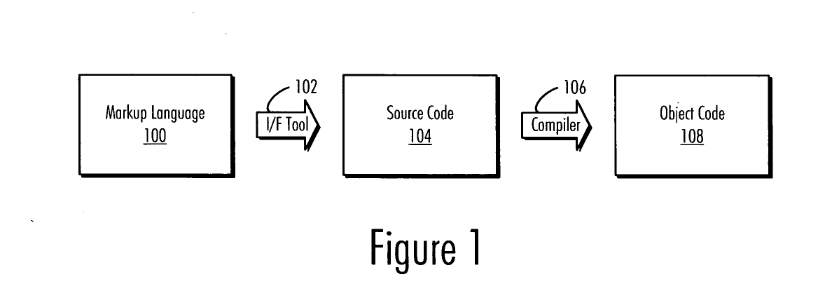

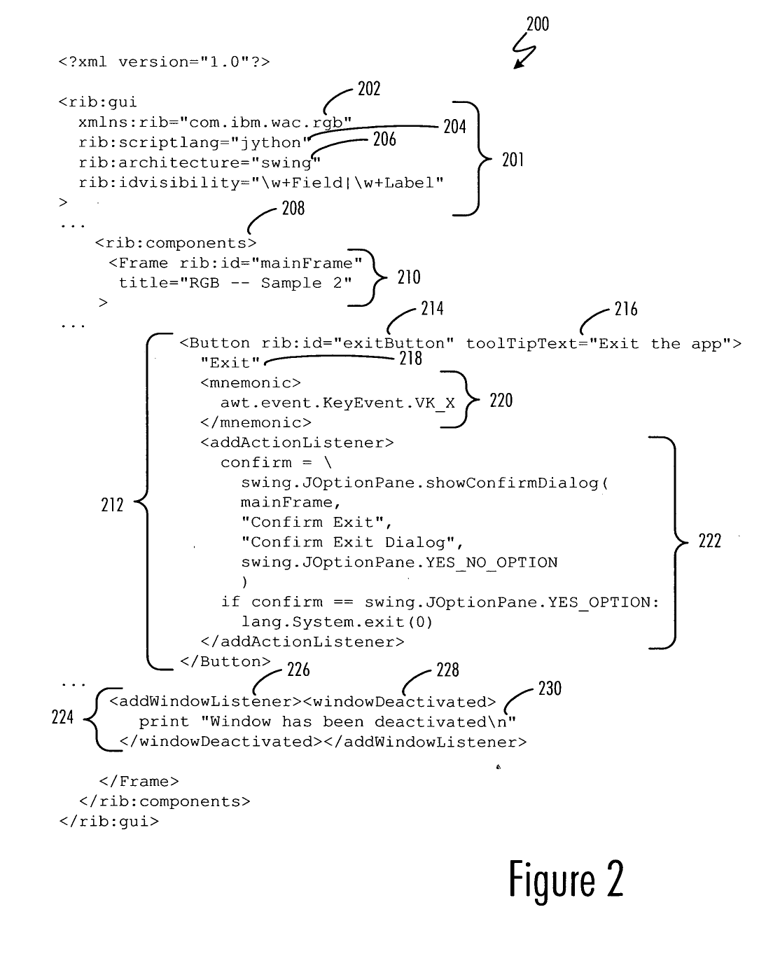

FIG. 1 is a diagram providing an overview of the operation of a graphical user interface tool 102 in accordance with a preferred embodiment of the present invention. A GUI is specified by the developer/programmer in the form of a document 100 written in a markup language, such as XML. Markup language document 100, as will be seen in subsequent figures, contains a declarative or descriptive representation of the GUI, but also contains non-markup program code intended to implement event-handling functionality in the resulting GUI code. FIG. 2 illustrates an example of such a markup language file. Interface tool 102 translates markup language document 100 into program source code 104.

In a preferred embodiment, source code 104 is in an object-oriented programming language having an object-oriented application programming interface (API) for writing GUIs. Examples of such languages include, but are not limited to, JAVA™ and Python (and, in particular, the Jython variant of Python, which is intended to execute in a JAVA™ runtime environment). One skilled in the art will recognize, however, that the methods of the present invention are, in general, programming-language independent and that source code 104 may be generated in any of a number of computer languages, without limitation and without departing from the scope and spirit of the present invention.

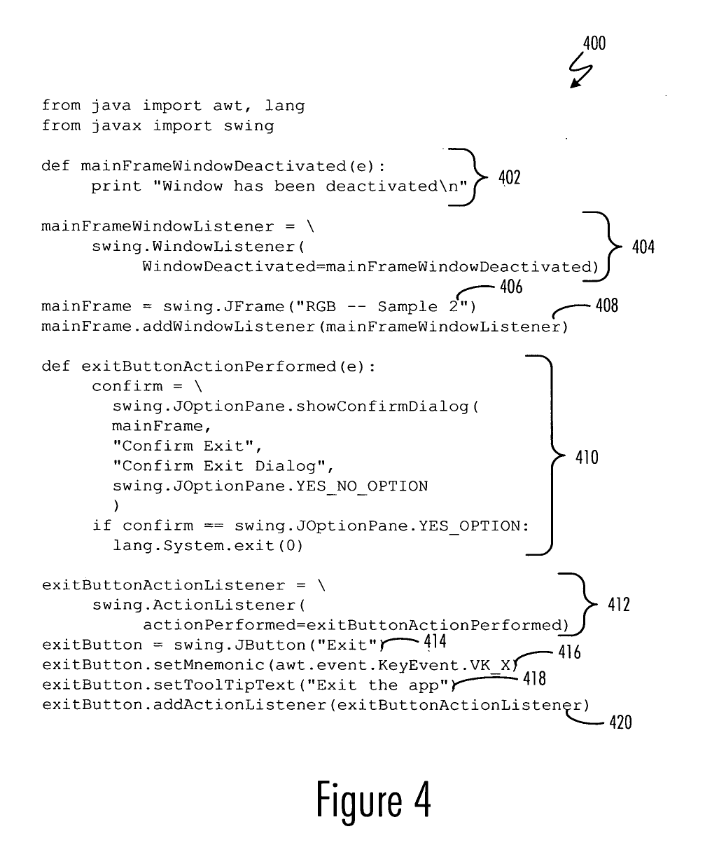

Source code 104 (an example of which is provided in FIG. 4) is then processed by a compiler 106 to generate object code 108, which (depending on the nature of the processing performed by compiler 106) may be executed as a complete program or linked into a larger application program, as desired.

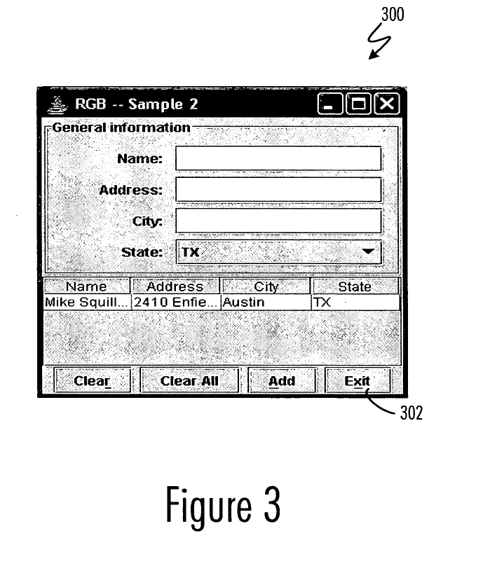

FIG. 2 is a diagram illustrating portions of a markup language file 200 in which GUI components and event handlers are specified declaratively in accordance with a preferred embodiment of the present invention. Markup language file 200 corresponds to dialog box 300, which is depicted in FIG. 3 (although it should be noted that only selected portions of markup language file 200 concerning button 302 and dialog box 300 as a whole are reflected in FIG. 2). Markup language file 200 is constructed hierarchically using XML and, when processed in accordance with a preferred embodiment of the present invention, is converted into program source code 400, as shown in FIG. 4. Outermost/top-level tag 201 is the root element of the hierarchy and sets forth the fundamental parameters of this XML GUI specification. In particular, top-level tag 201 includes attributes specifying an XML namespace 202, the selected scripting language for implementing event handlers 204 (in this example, “Jython”), and the GUI architecture or API used to construct the GUI 206 (in this example, the JAVA™ SWING API).

Frame tag 210, which is nested within top-level tag 201, represents dialog box 300 as a whole and contains attributes specifying an ID or name for dialog box 300 and a title to be displayed at the top of dialog box 300. As shown in FIG. 4, frame tag 210 causes the interface tool to generate line 406, which is a Jython command for creating a JFrame object in the JAVA™ SWING API. Nested within frame tag 210 (among other GUI component tags within frame tag 210) is button tag 212, which represents button 302 in FIG. 3. Button tag 212 contains an ID attribute 214 and an attribute for specifying text to be included in a tooltip 216. Button tag 212 is translated into lines 414 and 418 in source code 400, which create a JButton object to represent the button and set the tooltip text for the button, respectively. A tooltip is a small box or other GUI element containing a message that appears when the mouse cursor is allowed to rest over a particular GUI element for a certain length of time; tooltips are frequently used to aid a user in understanding the meaning of an icon or other unfamiliar GUI control. The text label for the button (text label 218) is nested within button tag 212 and is used in line 414 in source code 400 when generating the JButton, which is named “exitButton,” according to the ID provided in markup language file 200. Mnemonic tag 220 encloses a code for a keyboard equivalent for the button. A corresponding command is generated at line 416 of source code 400.

“addActionListener” tag 222 encloses a block of non-markup language program code, which is used to create an event handler (called an “event listener” in JAVA SWING parlance). Tags having a name that follows the naming convention “addXXXXListener,” as with addActionListener tag 222, are special-purpose tags that are used to generate event listeners in the resulting source code. This naming convention is identical to that employed in the JAVA SWING API for defining event listeners, which are subclasses of the parent “eventListener” class.

Subclasses of “eventListener” are intended to be used for monitoring various events in a SWING component. In the case of the “actionListener” event listener, the only event to monitor for is the “actionPerformed” event (corresponding to a user's clicking the button). Because of that, addActionListener tag 222 directly encloses the block of code to be executed in response to an “actionPerformed” event. Event listeners that can monitor for multiple types of events are specified in the manner shown at lines 224 in FIG. 2, where the “addWindowListener” tag 226 (which is capable of monitoring for multiple kinds of events concerning windows) encloses “windowDeactivated” tag 228, which, in turn, encloses a line of code 230 to be executed in response to a “windowDeactivated” event (which corresponds to the user's closing the window).

As can be seen in FIG. 4, “addActionListener” tag 222 results in the production of three constructs in source code 400. First, the block of code in “addActionListener” tag 222 is turned into a Jython function (function 410). Next, an instance of the JAVA SWING class “actionListener” is generated at line 412, where function 410 is assigned to the instance's “actionPerformed” attribute, so as to make function 410 the event-handling routine executed whenever the actionListener generated at line 412 detects an “actionPerformed” event. Finally, at line 420, the “addActionListener” method/function for the button (exitButton) is executed to activate the actionListener to monitor for events affecting the exitButton.

Lines 224 of markup language file 200, which relate to the window as a whole (i.e., the JFrame object representing the entire dialog box-“mainframe”) are translated similarly. The enclosed non-markup program code 230 from lines 224 is encapsulated into a Jython function 402. A new instance of windowListener is then created and function 402 is assigned to the “windowDeactivated” attribute of the new windowListener at line 404. Finally, the new windowListener is activated and assigned to the frame at line 408.

As one skilled in the art will recognize, by automatically generating GUI source code in this manner, the tedium of programming multiple sequentially executed commands to construct the GUI is alleviated. Further, because event handler code is incorporated into the GUI from the markup language file directly into the computer-generated GUI source code, there is no need for a programmer to make manual modifications to the generated code in order to allow events to be recognized and handled.

One skilled in the art will also recognize that in programming languages and/or runtime environments that support introspection, reflection, or functional programming facilities, many of the GUI-generation operations that, for example in FIG. 4, can be implemented through the generation of source code, can be performed using reflection, introspection, or functional methods. For example, the operations specified in lines 412, 414, 416, 418, and 420 in FIG. 4 could alternatively be performed using the JAVA™ Reflection API without having to generate additional source code for these operations.

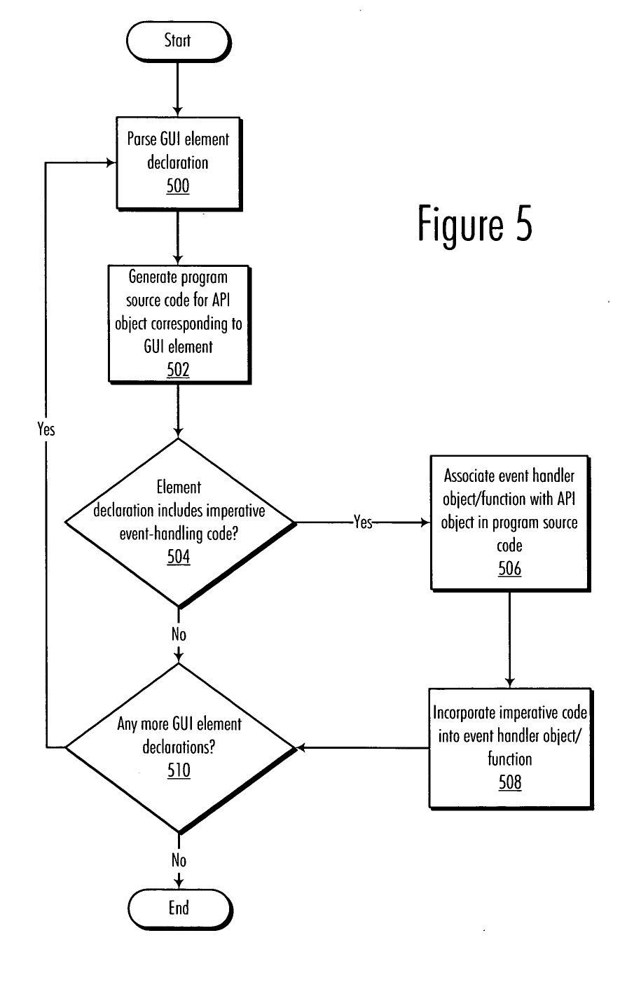

FIG. 5 is a flowchart representation of a process of generating GUI and event handler source code in an interface generation tool (such as interface tool 102 in FIG. 1) in accordance with a preferred embodiment of the present invention. First, the tool parses a GUI component declaration in the input markup language file (block 500). This declaration, its attributes, and its hierarchical position within the markup language file, are used to generate source code that produces the desired GUI component object in the appropriate API (block 502).

Next, a determination is made as to whether the component contains any embedded event-handling code (such as the example in FIG. 2) (block 504). If so (block 504:Yes), then event handler objects or functions (depending on the language and particular API used) are generated for each specified event, and those event handlers associated with the GUI component object in the output program source code (block 506). For each event handler so generated, the appropriate embedded event-handling code from the markup language file is directly incorporated into the source code of the event handler (block 508), as illustrated in FIG. 4.

If there are additional GUI components declared/described in the markup language document (block 510:Yes), the process cycles (returning to block 500) in order to generate source code for the other GUI components. Once all GUI component declarations have been processed (block 510:No), the process terminates.

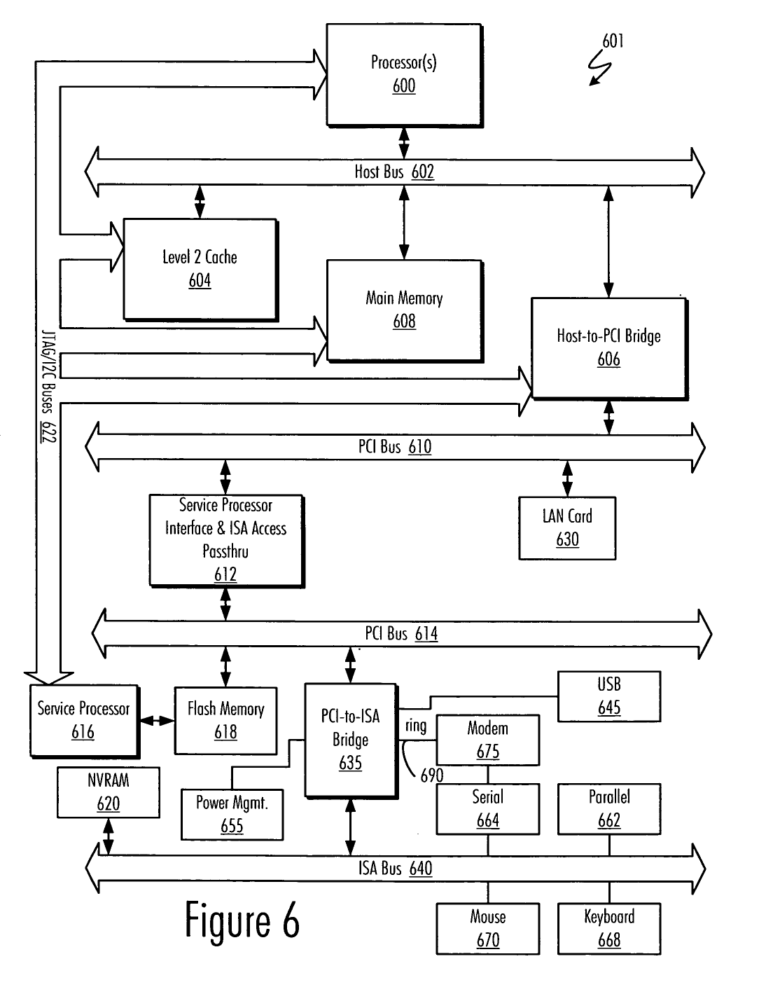

FIG. 6 illustrates information handling system 601 which is a simplified example of a computer system/server capable of performing the computing operations described herein with respect to a preferred embodiment of the present invention. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C buses 622 for communication with processor(s) 600 during initialization steps. JTAG/I2C buses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

What is claimed is:

1. A computer-implemented method comprising:
obtaining a declarative representation of a graphical user interface, wherein the declarative representation includes at least one portion of event-handling code;
generating program source code from the declarative representation, wherein the program source code contains instructions to construct the graphical user interface at runtime; and
incorporating the at least one portion of event-handling code into the program source code so as to make the at least one portion of event-handling code triggerable by the occurrence of at least one corresponding event at runtime.

2. The method of claim 1, wherein the declarative representation is expressed in a markup language.

3. The method of claim 2, wherein the markup language is Extensible Markup Language (XML).

4. The method of claim 1, wherein the event-handling code is imperative program code.

5. The method of claim 1, wherein the program source code is generated in an object-oriented programming language.

6. The method of claim 1, wherein the declarative representation has a hierarchical structure.

7. The method of claim 6, wherein the instructions to construct the graphical user interface at runtime include instructions to generate GUI components that are related to one another according to the hierarchical structure of the declarative representation.

8. A computer program product in a computer readable medium, comprising functional descriptive material that, when executed by a computer, directs the computer to perform actions that include:
obtaining a declarative representation of a graphical user interface, wherein the declarative representation includes at least one portion of event-handling code;
generating program source code from the declarative representation, wherein the program source code contains instructions to construct the graphical user interface at runtime; and
incorporating the at least one portion of event-handling code into the program source code so as to make the at least one portion of event-handling code triggerable by the occurrence of at least one corresponding event at runtime.

9. The computer program product of claim 8, wherein the declarative representation is expressed in a markup language.

10. The computer program product of claim 9, wherein the markup language is Extensible Markup Language (XML).

11. The computer program product of claim 8, wherein the event-handling code is imperative program code.

12. The computer program product of claim 8, wherein the program source code is generated in an object-oriented programming language.

13. The computer program product of claim 8, wherein the declarative representation has a hierarchical structure.

14. The computer program product of claim 13, wherein the instructions to construct the graphical user interface at runtime include instructions to generate GUI components that are related to one another according to the hierarchical structure of the declarative representation.

15. A data processing system comprising:
at least one processor;
memory associated with the at least one processor; and
a set of instructions in the memory, wherein the at least one processor executes the instructions to perform actions that include:
obtaining a declarative representation of a graphical user interface, wherein the declarative representation includes at least one portion of event-handling code;
generating program source code from the declarative representation, wherein the program source code contains instructions to construct the graphical user interface at runtime; and
incorporating the at least one portion of event-handling code into the program source code so as to make the at least one portion of event-handling code triggerable by the occurrence of at least one corresponding event at runtime.

16. The data processing system of claim 15, wherein the declarative representation is expressed in a markup language.

17. The data processing system of claim 16, wherein the markup language is Extensible Markup Language (XML).

18. The data processing system of claim 15, wherein the event-handling code is imperative program code.

19. The data processing system of claim 15, wherein the program source code is generated in an object-oriented programming language.

20. The data processing system of claim 15, wherein the declarative representation has a hierarchical structure.
